(19) United States
(12) Patent Application Publication
(10) Pub. No.: US 2014/0030051 A1
(43) Pub. Date: Jan. 30, 2014

(54) STACKER CRANE

(71) Applicant: MURATA MACHINERY, LTD., Kyoto-shi (JP)

(72) Inventor: Mitsuaki FUKAYAMA, Inuyama-shi (JP)

(73) Assignee: MURATA MACHINERY, LTD., Kyoto-shi (JP)

(21) Appl. No.: 13/787,904

(22) Filed: Mar. 7, 2013

(30) Foreign Application Priority Data
Jul. 26, 2012 (JP) 2012-166294

(51) Int. Cl. B66F 9/07

(52) U.S. Cl. CPC B66F 9/07
USPC 414/589

(57) ABSTRACT

A stacker crane includes a truck frame, a mast erected on the truck frame, and a platform raised and lowered along the mast, the platform including first and second rollers, the mast including a roller abutting member in which a first plate material is folded to define a first abutting surface onto which the first roller abuts and a second abutting surface onto which the second roller abuts, a back-side member made of a second plate material and arranged opposite to the roller abutting member, and a coupling member coupling the roller abutting member and the back-side member, the coupling member including first and second coupling surfaces which are plate-shaped and are opposite to each other, wherein the thickness of the first and second coupling surfaces is smaller than the thickness of the first plate material.

### BACKGROUND OF THE INVENTION

1. Field of the Invention

The present invention relates to a stacker crane including a platform that is raised and lowered along a mast erected on a truck frame.

2. Description of the Related Art

A conventional stacker crane includes a rack capable of mounting a plurality of loads thereon, wherein the loads are mounted on the rack and are taken out therefrom.

The stacker crane includes, e.g., a truck frame traveling on a lower rail provided on a floor surface along a rack, and a mast erected on the truck frame, wherein loads are passed between the stacker crane and the rack by using a transferring device provided on a platform that is raised and lowered along the mast.

Japanese Patent Application Laid-Open No. 2012-20846 discloses the details of a mast of such a stacker crane. Specifically, disclosed is a mast formed of a plurality of strut members, and including a ladder member.

Sometimes, the mast of the stacker crane has a height e.g., above 20 m, and the weight of loads raised and lowered by the platform is more than 3 tons (t). Therefore, as the material of the mast of the stacker crane, a square metal pipe which has a high rigidity and can be easily made is typically used.

That is, the square pipe selected as the material of the mast is subjected to cutting and coupling, so that the mast can have a predetermined height and a predetermined rigidity.

However, the shape of the square pipe is determined pursuant to standards. As the cross section of the square pipe perpendicular to the longitudinal direction thereof is larger, the thickness and weight thereof is increased.

In other words, as the rigidity required of the mast with the square pipe is higher, the weight thereof is increased. This can lower mobility required of the stacker crane.

### SUMMARY OF THE INVENTION

In view of the above conventional problems, preferred embodiments of the present invention provide a stacker crane including a mast which can secure a predetermined rigidity and can be reduced in weight.

A stacker crane according to a preferred embodiment of the present invention includes a truck frame; a platform that is raised and lowered, the platform including first and second rollers that raise and lower the platform guided by the mast, the first and second rollers having rotational axes crossing each other; and a mast erected on the truck frame and guiding the platform, the mast including a roller abutting member in which a first plate material is folded to define a first abutting surface onto which the first roller abuts and a second abutting surface onto which the second roller abuts, a back-side member made of a second plate material and arranged opposite to the roller abutting member, and a coupling member coupling the roller abutting member and the back-side member, the coupling member including first and second coupling surfaces which are plate-shaped and are arranged opposite to each other, wherein the thickness of the first and second coupling surfaces is smaller than the thickness of the first plate material.

According to this configuration, the mast preferably includes at least three members separated from each other (the roller abutting member, the back-side member, and the coupling member). Therefore, even when the cross section of the mast perpendicular or substantially perpendicular to the longitudinal direction thereof is made larger, the thickness of each of the members can be independently determined.

Specifically, with the mast according to the present preferred embodiment of the present invention, the thickness of the coupling member preferably is smaller than the thickness of the roller abutting member. That is, while the thickness of the roller abutting member onto which a large load is applied is relatively large, the thickness of the coupling member is relatively small.

In brief, in the mast according to this preferred embodiment of the present invention, the portion requiring a high rigidity and the portion not requiring a high rigidity can have different thicknesses. As a result, the rigidity necessary for the entire mast can be secured, and the mast can be reduced in weight.

At least three members (the roller abutting member, the back-side member, and the coupling member) preferably are joined to complete the mast as an integral unit. Therefore, the mast can be made relatively easily.

In the stacker crane according to another preferred embodiment of the present invention, the mast may include a plurality of roller abutting members, a plurality of back-side members, and a plurality of coupling members, the roller abutting members may be aligned in a height direction, the back-side members may be aligned in the height direction, and the coupling members may be aligned in the height direction, and the mast may further include a connecting member connecting at least adjacent pairs of the roller abutting members.

According to this configuration, for instance, the mast can have various heights. In addition, the roller abutting members which are adjacent vertically are connected by the connecting member. Therefore, a reinforcing effect provided by the connecting member is obtained.

In the stacker crane according to another preferred embodiment of the present invention, the plurality of roller abutting members, the plurality of back-side members, and the plurality of coupling members may be arranged in the mast such that at least one boundary position between the aligned roller abutting members is not the same in the height direction as at least one of the boundary position between the back-side members and the boundary position between the coupling members.

According to this configuration, at least one portion in which all of the joint between the roller abutting members, the joint between the coupling members, and the joint between the back-side members are in the same height position is provided in the mast. Therefore, for instance, the assembling accuracy of the mast can be improved. In addition, for instance, the portions having a lower strength than other portions are distributed in the height direction.

In the stacker crane according to a preferred embodiment of the present invention, in the at least two back-side members, the back-side member arranged in the lower position may have a larger thickness than the back-side member arranged in the higher position.

According to this configuration, the thickness of the lower back-side member onto which a large dynamic load including the self weight and moment of the mast is applied can be larger than the thickness of the upper back-side member. In other words, the thickness of the upper back-side member can be smaller than the thickness of the lower back-side member.

As a result, in the mast, the rigidity of the portion requiring a higher rigidity can be improved, and the weight of the entire mast can be reduced.

In the stacker crane according to a preferred embodiment of the present invention, each of the back-side members maybe formed preferably by folding the second plate material, and may be sandwiched between the first and second coupling surfaces of the coupling member.

According to this configuration, for instance, even when the entire thickness of the back-side members is larger in lower portions, each of the back-side members can be readily joined to the first and second coupling surfaces.

In the stacker crane according to a preferred embodiment of the present invention, each of the back-side members may be arranged in the position in which the surface thereof opposite to the roller abutting member is flat.

According to this configuration, no steps can be caused between the adjacent back-side members of the mast even when the back-side members have different thicknesses.

In the stacker crane according to a preferred embodiment of the present invention, the coupling member may have a through-hole formed by removing material from at least one of the first and second coupling surfaces and thus reducing weight, and a bulging portion bulging outward or inward, the bulging portion increasing the strength of the coupling member.

According to this configuration, the coupling member can be further reduced in weight by removing material, and by providing the bulging portion, lowering of the strength of the coupling member due to removing material can be prevented.

In the stacker crane according to a preferred embodiment of the present invention, the coupling member may include the first and second coupling surfaces, which are separated from each other.

According to this configuration, the first and second coupling surfaces are separated from each other, and are independent in the mast. For instance, the first and second coupling surfaces alternate in the height direction. Therefore, the degree of freedom of the configuration of the mast can be improved. In addition, for instance, a plurality of identical plate-shaped members can be used as the first and second coupling surfaces.

Further, yet another preferred embodiment of the present invention provides a method of manufacturing the mast included in the stacker crane according to any one of the preferred embodiments of the present invention described above.

According to various preferred embodiments of the present invention, a stacker crane including a mast which can secure a predetermined rigidity and can be reduced in weight can be provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating the outline of the configuration of an automated storage according to a preferred embodiment of the present invention.

FIG. 2 is a perspective view illustrating the appearance of a mast according to a preferred embodiment of the present invention.

FIG. 3 is an exploded perspective view of the mast according to a preferred embodiment of the present invention.

FIG. 4 is a diagram illustrating the cross-sectional configuration of the mast and the position relation between the mast and each guide roller of a platform according to a preferred embodiment of the present invention.

FIG. 5 is a diagram illustrating the boundary positions between aligned roller abutting members, back-side members, and coupling members according to a preferred embodiment of the present invention.

FIG. 6A is a top view illustrating an example of the attaching configuration of a first connecting member to each roller abutting member according to a preferred embodiment of the present invention.

FIG. 6B is a top view illustrating an example of the attaching configuration of a second connecting member to each back-side member according to a preferred embodiment of the present invention.

FIG. 7 is a longitudinal sectional view of assistance in explaining the relation between the position in the height direction and the thickness of each back-side member according to a preferred embodiment of the present invention.

FIG. 8 is a top view corresponding to FIG. 7.

FIG. 9A is a side view illustrating a first example of a bulging portion provided in each coupling member.

FIG. 9B is a cross-sectional view taken along line A-A corresponding to FIG. 9A.

FIG. 9C is a side view illustrating a second example of a bulging portion provided in each coupling member.

FIG. 9D is a cross-sectional view taken along line B-B corresponding to FIG. 9C.

FIG. 10 is a diagram of assistance in explaining each third abutting surface of each roller abutting member.

FIGS. 11A, 11B, and 11C are first diagrams illustrating a plurality of modification examples of the cross-sectional configuration of the mast.

FIGS. 12A, 12B, and 12C are second diagrams illustrating a plurality of modification examples of the cross-sectional configuration of the mast.

### DETAILED DESCRIPTION OF THE PREFERRED EMBODIMENTS

Hereinafter, a stacker crane of preferred embodiments of the present invention will be described with reference to the drawings. The drawings are schematic, and do not always illustrate the stacker crane exactly.

In addition, the preferred embodiments which will be described below illustrate specific non-limiting examples of the present invention. The values, the shapes, the materials, the components, the arranged positions and connected states of the components, the assembling method, and the assembling order, which will be illustrated in the preferred embodiments are only examples, and are not intended to limit the present invention. Further, the components in the preferred embodiments which are not described in the independent claim(s) representing a generic concept will be described as optional components.

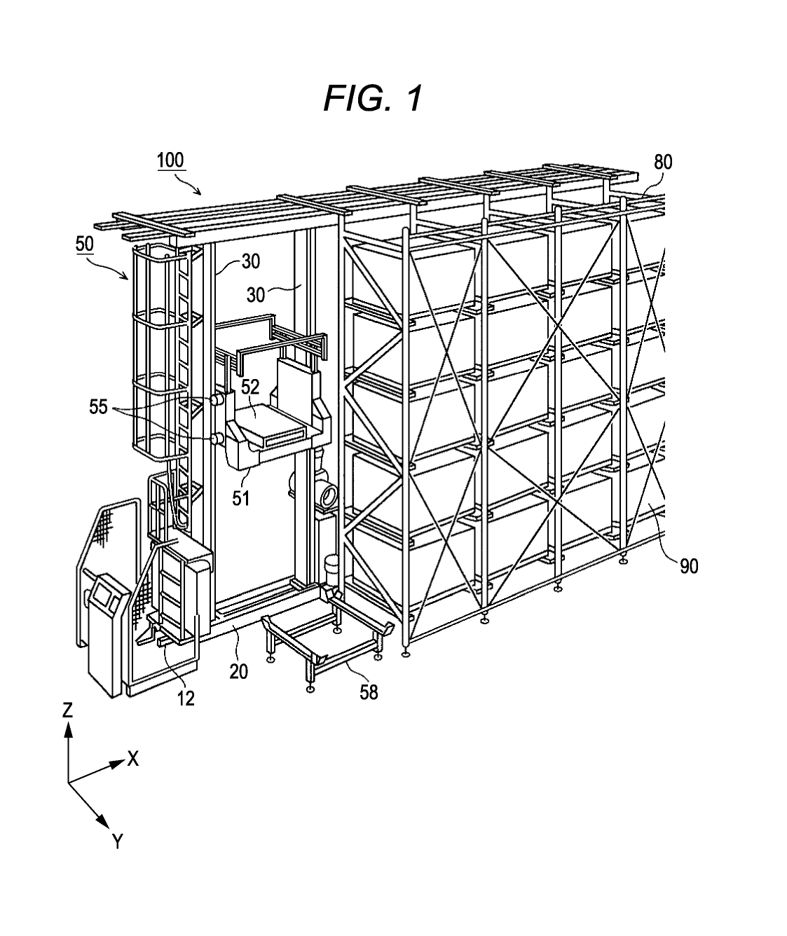

First, referring to FIG. 1, the outline of the configurations of an automated storage 100 and a stacker crane 50 according to a preferred embodiment of the present invention will be described.

FIG. 1 is a perspective view illustrating the outline of the configuration of the automated storage 100 according to the present preferred embodiment.

As illustrated in FIG. 1, the automated storage 100 according to the present preferred embodiment includes a rack 80 on which a plurality of loads 90 can be mounted, and the stacker crane 50.

The stacker crane 50 includes a truck frame 20 traveling along a lower rail 12, a mast 30 erected on the truck frame 20, and a platform 51 that is raised and lowered along the mast 30.

In this preferred embodiment, the truck frame 20 preferably includes two masts 30, and the platform 51 includes a plurality of guide rollers including first rollers 55, for example.

The platform 51 arranged between the masts 30 is guided by the masts 30 to be raised and lowered in a state where the guide rollers abut onto the masts 30.

Although not illustrated in FIG. 1, the upper ends of the masts 30 are connected to e.g., an upper truck frame traveling along an upper rail.

That is, the truck frame 20 travels along the lower rail 12, and the upper truck frame travels along the upper rail, so that the entire stacker crane 50 moves in the X-axis direction.

A transferring device 52 is arranged on the platform 51 included in the stacker crane 50. The transferring device 52 according to this preferred embodiment preferably uses a method of transferring the loads 90 by a slide fork, for example. However, the present invention is not particularly limited to the transferring method used by the transferring device 52.

The stacker crane 50 travels along the lower rail 12 to raise and lower the platform 51, and extends and retracts the slide fork of the transferring device 52. The stacker crane 50 includes such a configuration to pass each load 90 between the rack 80 and a station 58.

The station 58 is a member on which each load 90 is temporarily placed. For instance, each load 90 mounted on the rack 80 is temporarily placed on the station 58, and is then conveyed out of the automated storage 100.

The stacker crane 50 according to this preferred embodiment has a configuration feature of the mast 30. In brief, folded sheet metals are preferably combined to manufacture the mast 30, for example.

The masts 30 aligned in the X-axis direction in FIG. 1 preferably have the same configuration feature. Hereinafter, the configuration feature of the left mast 30 in FIG. 1 will be described with reference to the drawings.

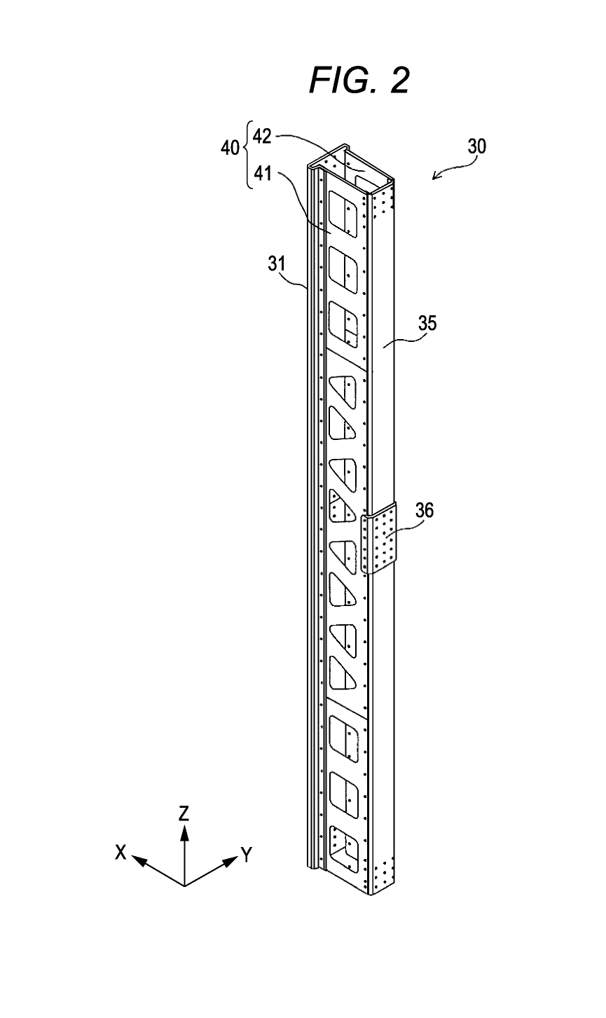

FIG. 2 is a perspective view illustrating the appearance of the mast 30 according to the present preferred embodiment.

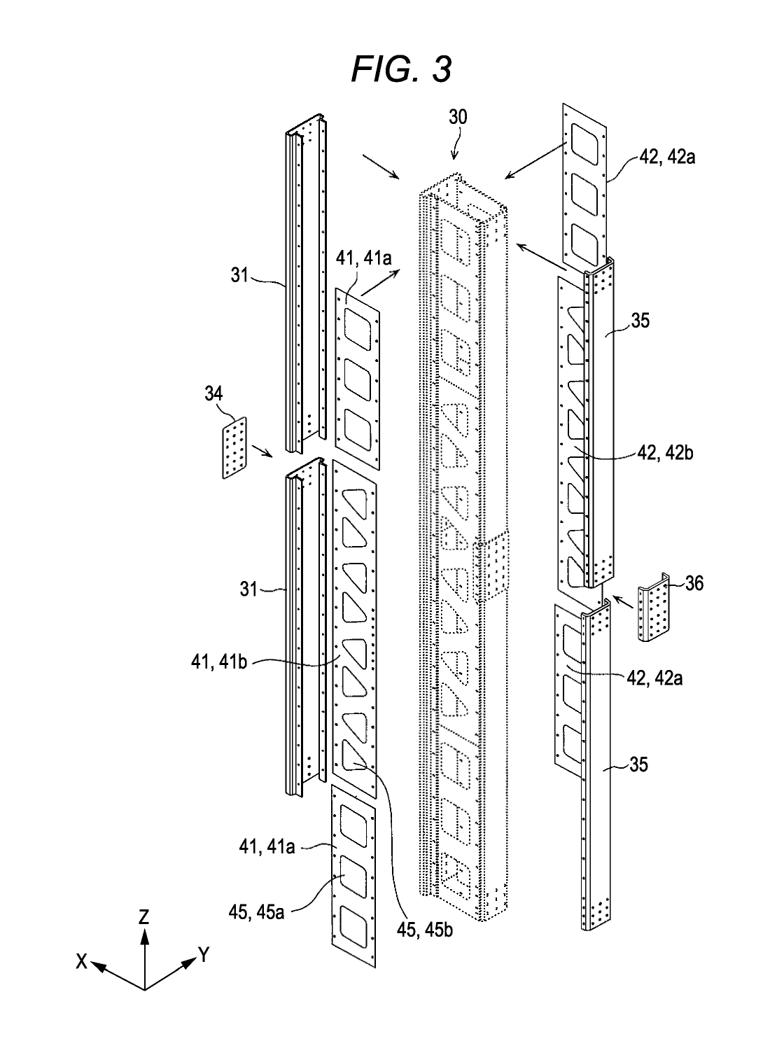

FIG. 3 is an exploded perspective view of the mast 30 according to the present preferred embodiment.

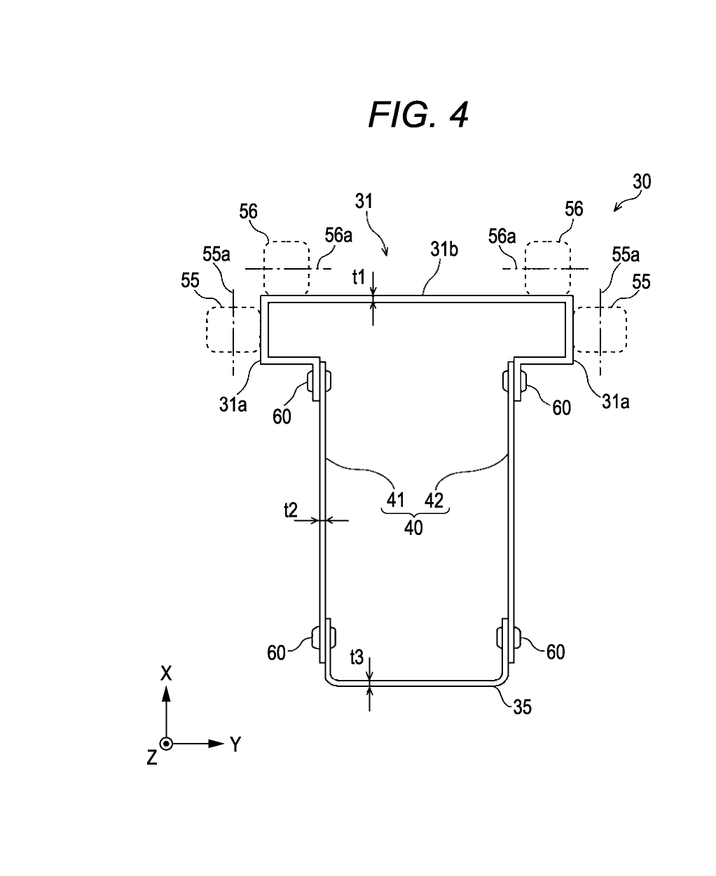

FIG. 4 is a diagram illustrating the cross-sectional configuration of the mast 30 and the position relation between the mast 30 and each guide roller of the platform 51 according to the present preferred embodiment.

FIG. 2 illustrates the mast 30 having a length as a predetermined unit. For instance, a plurality of masts 30 each illustrated in FIG. 2 are coupled to a necessary height in a height direction (Z-axis direction).

For instance, a plurality of masts 30 are coupled at a location where the stacker crane 50 is installed so as to have a height required of the stacker crane 50.

Each mast 30 according to the present preferred embodiment preferably includes a roller abutting member 31, a back-side member 35, and a coupling member 40.

The roller abutting member 31 is a member in which a first plate material is folded to define a first abutting surface 31a onto which each of the first rollers 55 abuts and a second abutting surface 31b onto which a second roller 56 abuts.

The first roller 55 and the second roller 56 are the guide rollers included in the platform 51. As illustrated in FIG. 4, a rotational axis 55a of the first roller 55 and a rotational axis 56a of the second roller 56 cross each other.

The first roller 55 and the second roller 56 are preferably arranged so that their rotational axes cross each other. The positions in the height direction of the rotational axes of the first roller 55 and the second roller 56 may be different.

In this preferred embodiment, the rotational axis 55a of the first roller 55 and the rotational axis 56a of the second roller 56 preferably are perpendicular or substantially perpendicular to each other. That is, the first plate material is preferably folded at a right angle (or a substantially right angle) to define the first abutting surface 31a and the second abutting surface 31b.

In addition, in this preferred embodiment, the two first rollers 55 and the two second rollers 56 are arranged on the right and left sides in FIG. 4 of the platform 51 to sandwich the mast 30 therebetween. For instance, a set of four guide rollers preferably is arranged vertically on the platform 51. In this case, the platform 51 preferably includes a total of eight guide rollers which abut onto the one mast 30.

The back-side member 35 is preferably made of a second plate material, and is opposite to the roller abutting member 31.

The coupling member 40 is a member coupling the roller abutting member 31 and the back-side member 35. The coupling member 40 includes a first coupling surface 41 and a second coupling surface 42, which are plate-shaped and are opposite to each other.

The mast 30 of this preferred embodiment is preferably formed by combining such members, as illustrated in FIG. 3.

Specifically, in the mast 30, a plurality of roller abutting members 31, back-side members 35, and coupling members 40 are aligned in the height direction.

The adjacent two roller abutting members 31 are connected by a first connecting member 34. The adjacent two back-side members 35 are connected by a second connecting member 36.

As the first plate material, the second plate material, and the material of the coupling member 40, for instance, SS400 (JIS standards) or SPHC (Steel Plate Hot Commercial) (JIS standards) which is a kind of rolled steel for general structure is preferably used. Likewise, as the plate material of the first connecting member 34 and the second connecting member 36, SS400 or SPHC is preferably used. Other materials which can obtain a predetermined rigidity may be adopted for these members.

In this preferred embodiment, as illustrated in FIG. 4, a fastening member 60 realized by a bolt or rivet, for example, is preferably used to join the roller abutting member 31 and the coupling member 40.

More specifically, a one-side bolt or a blind rivet which enables fastening in a one-side operation may be preferably used as the fastening member 60, for example.

As illustrated in FIG. 3, the thickness of the first coupling surface 41 and the second coupling surface 42 of the mast 30 is smaller than the thickness of the first plate material.

Specifically, when t1 is the thickness of the first plate material (roller abutting member 31) and t2 is the thickness of the first coupling surface 41 and the second coupling surface 42, t1 preferably is, e.g., about 5 mm and t2 is e.g., about 3 mm.

In addition, when t3 is the thickness of the second plate material (back-side member 35), t3 preferably is, e.g., about 3 mm to about 5 mm.

In this way, the thickness of the mast 30 according to this preferred embodiment is partially different. Specifically, the mast 30 preferably includes the roller abutting member 31, the back-side member 35, and the coupling member 40, which are separated from each other. Therefore, the thickness of each of the members can be independently determined.

In this preferred embodiment, the thickness of the roller abutting member 31 onto which a large load is applied by the abutting of a plurality of guide rollers of the platform 51 is relatively large, and the thickness of the coupling member 40 is relatively small.

That is, in the mast 30, the portion requiring a high rigidity and the portion not requiring a high rigidity have different thicknesses. As a result, a rigidity necessary for the entire mast 30 can be secured, and the mast 30 can be reduced in weight.

Specifically, the weight of the mast 30 can be reduced to about half of the weight of each conventional square pipe having about the same rigidity as the mast 30.

Therefore, by adopting the mast 30 of this preferred embodiment, the mobility of the stacker crane 50 can be improved. Specifically, for instance, the acceleration, deceleration, and stop of the moving in the X-axis direction required of the stacker crane 50 can be safely performed with a smaller energy than each conventional stacker crane.

In this preferred embodiment, a plurality of first coupling surfaces 41 preferably include a first coupling surface 41a and a first coupling surface 41b, which have different lengths (dimensions in the height direction).

Likewise, a plurality of second coupling surfaces 42 preferably include a second coupling surface 42a and a second coupling surface 42b, which have different lengths.

In this preferred embodiment, as illustrated in FIG. 3, the lengths of the roller abutting member 31 and the back-side member 35 preferably are the same (or substantially the same; the same shall apply hereinafter), and the total length of the two roller abutting members 31 and the total length of the two first coupling surfaces 41a and the one first coupling surface 41b are preferably the same. In addition, the total length of the two roller abutting members 31 and the total length of the two second coupling surfaces 42a and the one second coupling surface 42b preferably are the same.

For instance, the roller abutting member 31, the back-side member 35, the first coupling surface 41b, and the second coupling surface 42b preferably has a length of about 1.7 m, and the first coupling surface 41a and the second coupling surface 42a preferably has a length of 0.85 m. In this case, the length (height) of the mast 30 illustrated in FIGS. 2 and 3 preferably is about 3.4 m, for example.

In this preferred embodiment, a plurality of roller abutting members 31, back-side members 35, and coupling members 40 are arranged in the mast 30 such that at least one boundary position between the aligned roller abutting members 31 is not the same in the height direction as at least one of the boundary position between the back-side members 35 and the boundary position between the coupling members 40. That is, the length of at least one portion of at least one of the back-side member 35 and the coupling member 40 which are horizontally overlapped with the roller abutting member 31 is different from the length of the roller abutting member 31.

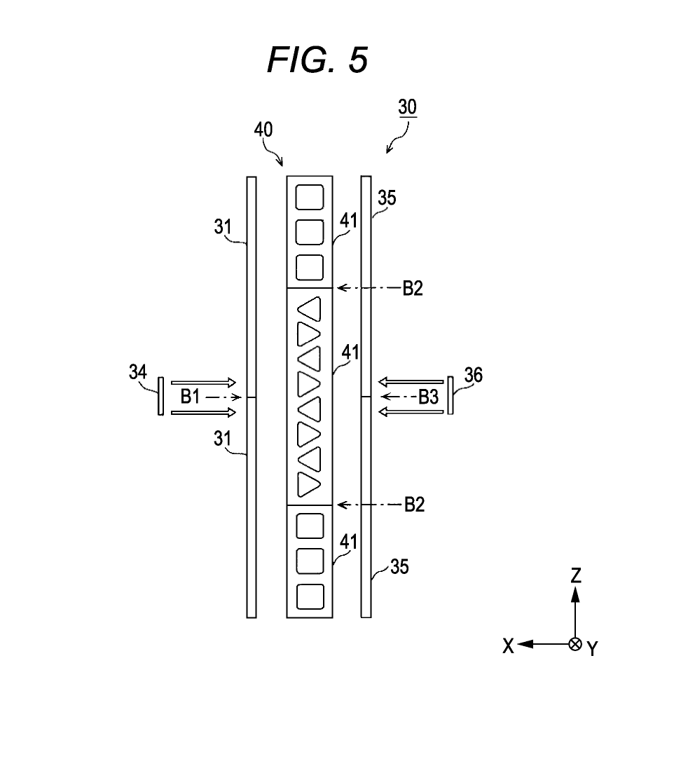

FIG. 5 is a diagram illustrating the boundary positions between the aligned roller abutting members 31, the back-side members 35, and the coupling members 40 according to the present preferred embodiment.

In this preferred embodiment, for instance, as illustrated in FIG. 2, the first coupling surfaces 41a and 41b are alternates, and the second coupling surfaces 42a and 42b are alternates.

As a result, as illustrated in FIG. 5, the position in the height direction of boundary B1 between the roller abutting members 31 is different from the position in the height direction of boundary B2 between the first coupling surfaces 41a and 41b, that is, the position in the height direction of boundary B2 between the coupling members 40.

In this way, the position of the boundary between members aligned in the height direction is shifted in the height direction from the position of the boundary between different members. For instance, the assembling accuracy of the mast 30 can be improved, thus improving the straightness in the height direction of the mast 30. In addition, for instance, the boundary portions having a lower strength than other portions can be distributed in the height direction. As a result, the resistance of the mast 30 to the bending moment can be improved.

In this preferred embodiment, the position in the height direction of boundary B1 between the roller abutting members 31 and the position in the height direction of boundary B3 between the back-side members 35 preferably are the same. However, boundary B1 and boundary B3 may be shifted in the height direction.

As described above, the mast 30 of this preferred embodiment includes the first connecting member 34 connecting the adjacent two roller abutting members 31, and the second connecting member 36 connecting the adjacent two back-side members 35.

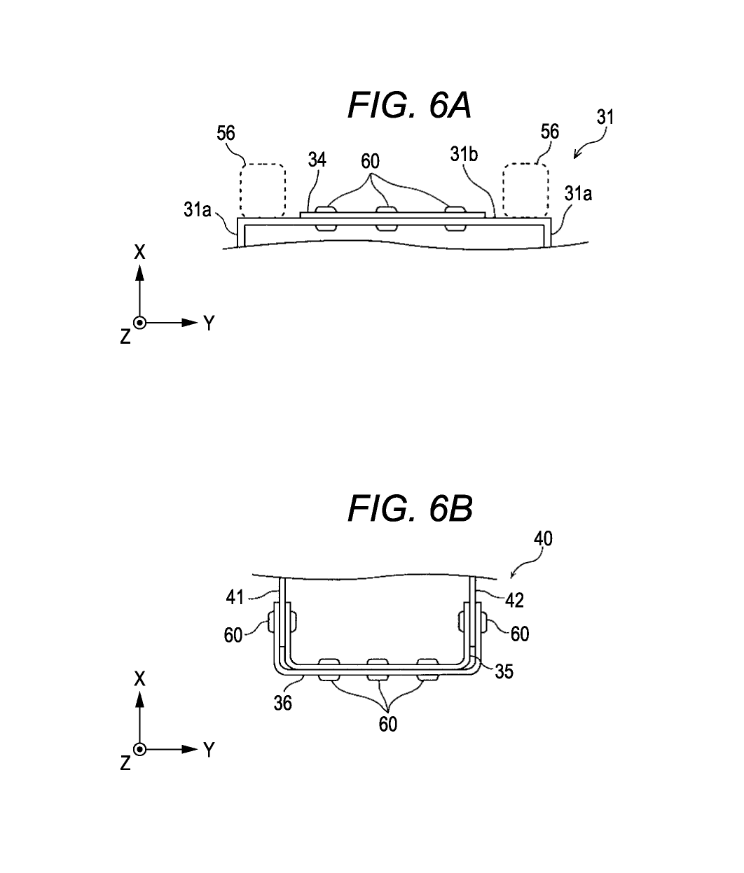

FIG. 6A is a top view illustrating an example of the attaching configuration of the first connecting member 34 to the roller abutting member 31 according to the present preferred embodiment.

FIG. 6B is a top view illustrating an example of the attaching configuration of the second connecting member 36 to the back-side member 35 according to the present preferred embodiment.

As illustrated in FIG. 6A, the width in the Y-axis direction of the first connecting member 34 is smaller than the width in the Y-axis direction of the roller abutting member 31. Therefore, the moving of the two second rollers 56 aligned in the Y-axis direction along the second abutting surface 31b cannot be inhibited by the first connecting member 34.

In addition, the first connecting member 34 extends across the boundary between the adjacent two roller abutting members 31, and is joined to the roller abutting members 31 by a plurality of fastening members 60.

The first connecting member 34 is arranged in the mast 30 in this manner. Therefore, the boundary portion between the roller abutting members 31 can be reinforced.

As illustrated in FIG. 6B, the second connecting member 36 is joined to a plurality of back-side members 35 by a plurality of fastening members 60, and is joined to a plurality of coupling members 40 by a plurality of fastening members 60.

That is, the second connecting member 36 extends across the boundary between the adjacent two back-side members 35, and is joined to the back-side members 35 by a plurality of fastening members 60. As a result, the boundary portion between the back-side members 35 is reinforced.

The second connecting member 36 is also joined to a plurality of coupling members 40 by a plurality of fastening members 60. Therefore, the second connecting member 36 defines and functions as a reinforcing member in the joining between the two back-side members 35 and the coupling members 40.

The second connecting member 36 may be divided into e.g., one member parallel to the Y-axis and two members parallel to the X-axis. In addition, as only one member parallel to the Y-axis, the second connecting member 36 may be joined only to the two back-side members 35 without being joined to the coupling members 40.

In this preferred embodiment, as illustrated in FIG. 4, in three members of the roller abutting member 31, the back-side member 35, and the coupling member 40, thickness t1 of the roller abutting member is larger than thickness t2 of the coupling member 40. In addition, thickness t3 of the back-side member 35 is equal to or above thickness t2 of the coupling member 40.

Here, for instance, the thickness of each of the three members may be different according to the position thereof in the height direction.

For instance, thickness t3 of the back-side member 35 may be different according to the position thereof in the height direction.

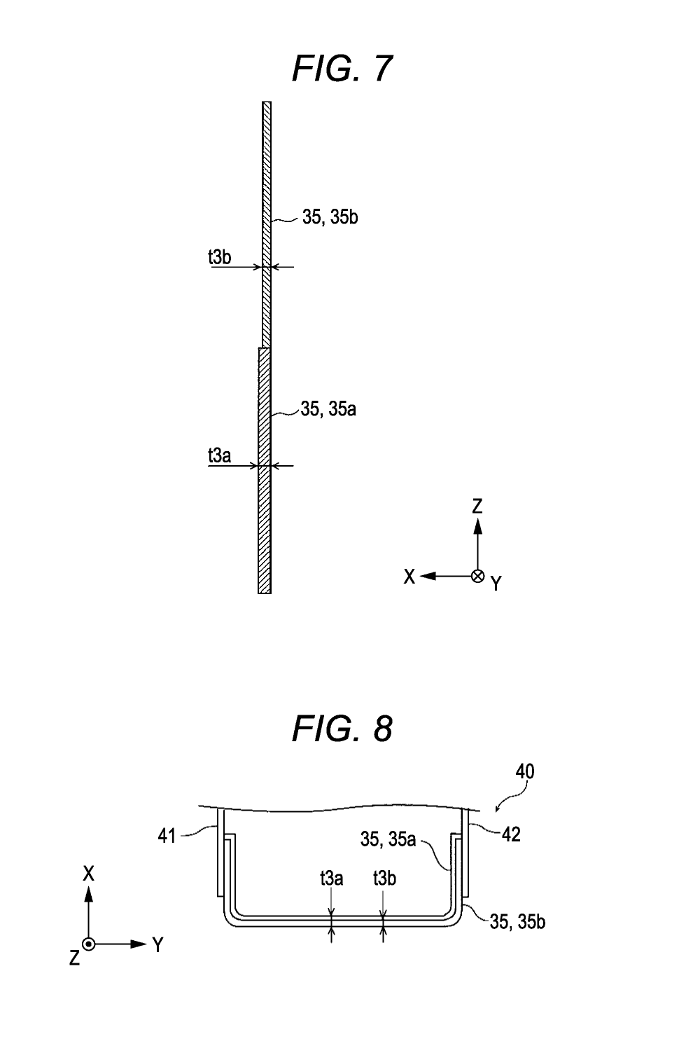

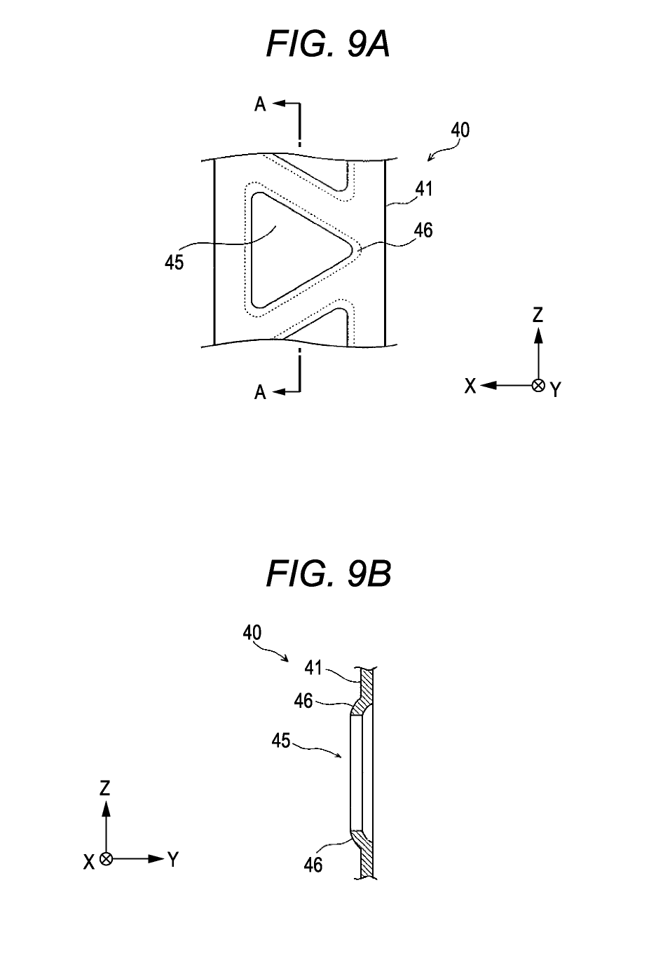

FIG. 7 is a longitudinal sectional view of assistance in explaining the relation between the position in the height direction and the thickness of each back-side member 35 according to the present preferred embodiment, and FIG. 8 is a top view corresponding to FIG. 7.

For instance, in the two back-side members 35 aligned in the height direction, the one back-side member 35 arranged in the lower position is aback-side member 35a, and the other back-side member 35 arranged in the higher position is a back-side member 35b. In addition, t3a is the thickness of the back-side member 35a, and t3b is the thickness of the back-side member 35b.

In this case, t3a may be larger than t3b. That is, the thickness of the back-side member 35a arranged in the lower position maybe larger than the thickness of the back-side member 35b arranged in the higher position.

That is, the thickness of the back-side member 35 in the lower portion of the mast 30, onto which a large dynamical load including the self weight and moment of the mast 30 is applied is larger than the thickness of the back-side member 35 in the upper position of the mast 30. In other words, the thickness of the upper back-side member 35 is smaller than the thickness of the lower back-side member 35.

As a result, the rigidity of the portion of the mast 30 requiring a higher rigidity can be improved, and the weight of the entire mast 30 can be reduced.

In addition, in this preferred embodiment, each of a plurality of back-side members 35 preferably is formed by folding the second plate material (for instance, see FIG. 4), and is sandwiched between the first coupling surface 41 and the second coupling surface 42 of the coupling member 40.

Therefore, as illustrated in FIG. 8, the two back-side members 35 (35a, 35b) aligned in the height direction (Z-axis direction) can be arranged so that the outside surfaces thereof (the surfaces on the opposite side of the roller abutting member 31 (the surfaces on the X-axis negative side)) are flat and do not include steps.

This is also true for the case in which three or more back-side members 35 are aligned in the height direction. That is, the entire thickness of three or more back-side members 35 aligned in the height direction can be larger downward (or can be smaller upward), and three or more back-side members 35 can be arranged so that their outside surfaces are flat and without steps.

As illustrated in FIG. 3, each coupling member 40 (the first coupling surface 41 and the second coupling surface 42) of this preferred embodiment includes a plurality of through-holes 45 formed by removing material so as to reduce weight.

In this preferred embodiment, each through-hole 45 preferably is a through-hole 45a in a wholly square shape or a through-hole 45b in a wholly triangular shape, for example. However, the present invention is not particularly limited to any particular shape of the through-hole 45.

When each coupling member 40 is subjected to removing material and reducing weight in this manner, a process for preventing the strength of the coupling member 40 from being lowered may be added. For instance, the coupling member 40 may have a bulging portion obtained by pressing.

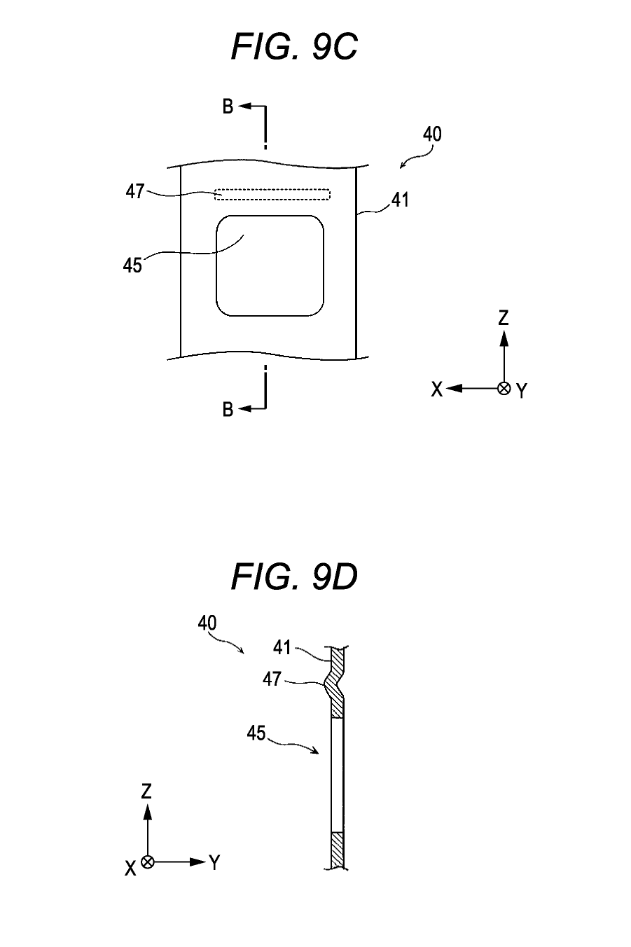

FIG. 9A is a side view illustrating a first example of the bulging portion provided in each coupling member 40, and FIG. 9B is a cross-sectional view taken along line A-A corresponding to FIG. 9A.

FIG. 9C is a side view illustrating a second example of the bulging portion provided in each coupling member 40, and FIG. 9D is a cross-sectional view taken along line B-B corresponding to FIG. 9C.

FIGS. 9A to 9D illustrate each through-hole 45 and bulging portions 46 and 47 provided in the first coupling surface 41. Likewise, each through-hole 45 and the bulging portions 46 and 47 can be provided in the second coupling surface 42.

For instance, as illustrated in FIGS. 9A and 9B, the bulging portion 46 may be provided along the peripheral edge of the through-hole 45.

In addition, for instance, as illustrated in FIGS. 9C and 9D, the bulging portion 47 may be provided away from the through-hole 45.

In either case, the bulging portions 46 and 47 can be easily formed integrally with the coupling member 40, and function as ribs which can improve the strength of the coupling member 40.

For instance, the bulging portion 46 or 47 having a size more than half of the entire width of the first coupling surface 41 is preferably provided in the width direction (X-axis direction) of the first coupling surface 41. Therefore, the strength of the coupling member 40 can be improved as compared with a case where the bulging portion 46 or 47 is not present.

The through-hole 45 and the bulging portion 46 or 47 are provided in the coupling member 40 in this manner. Therefore, the weight of the coupling member 40 can be effectively reduced, and lowering of the strength of the coupling member 40 due to the provided through-hole 45 can be prevented.

In this preferred embodiment, for instance, as illustrated in FIG. 4, each end in the Y-axis direction of the roller abutting member 31 is projected in the cross section of the mast 30.

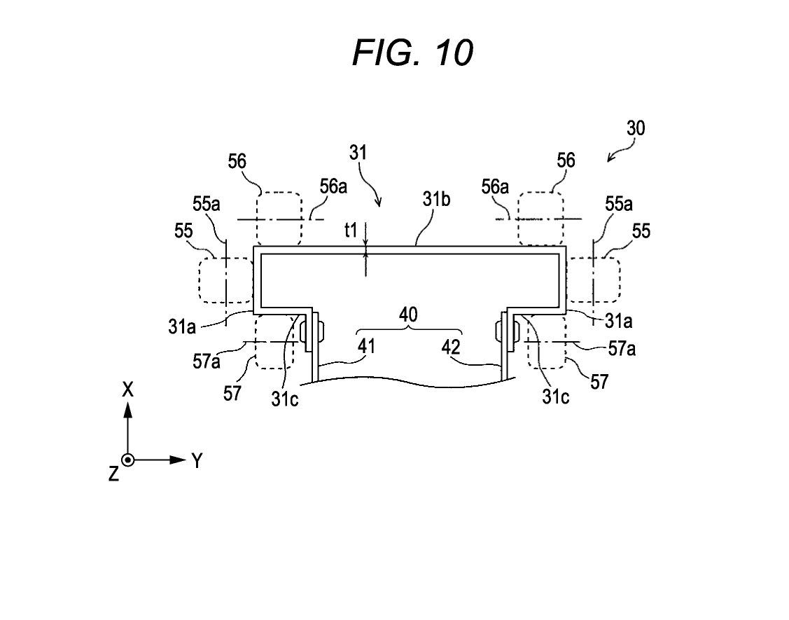

This is because, as illustrated in FIG. 10, a third abutting surface 31c is provided on the roller abutting member 31 in order for the platform 51 to include a third roller 57 as the guide roller abutting onto the roller abutting member 31.

For instance, the third roller 57 is the guide roller which is opposite to the second roller 56 across the roller abutting member 31 and is rotated about a rotational axis 57a parallel or substantially parallel to the rotational axis 56a of the second roller 56.

For instance, when the platform 50 being raised and lowered is supported by one mast, not by the two masts 30, the third roller 57 is provided on the platform 51.

The roller abutting member 31 includes the third abutting surface 31c in this manner. In the stacker crane 50 including one strut which guides the raising and lowering of the platform 51, the mast 30 of this preferred embodiment can be adopted as the strut.

As in the stacker crane 50 of this preferred embodiment, when the two masts 30 are used as struts which guide the raising and lowering of the platform 51, the roller abutting member 31 is not required to be projected at each end in the Y-axis direction.

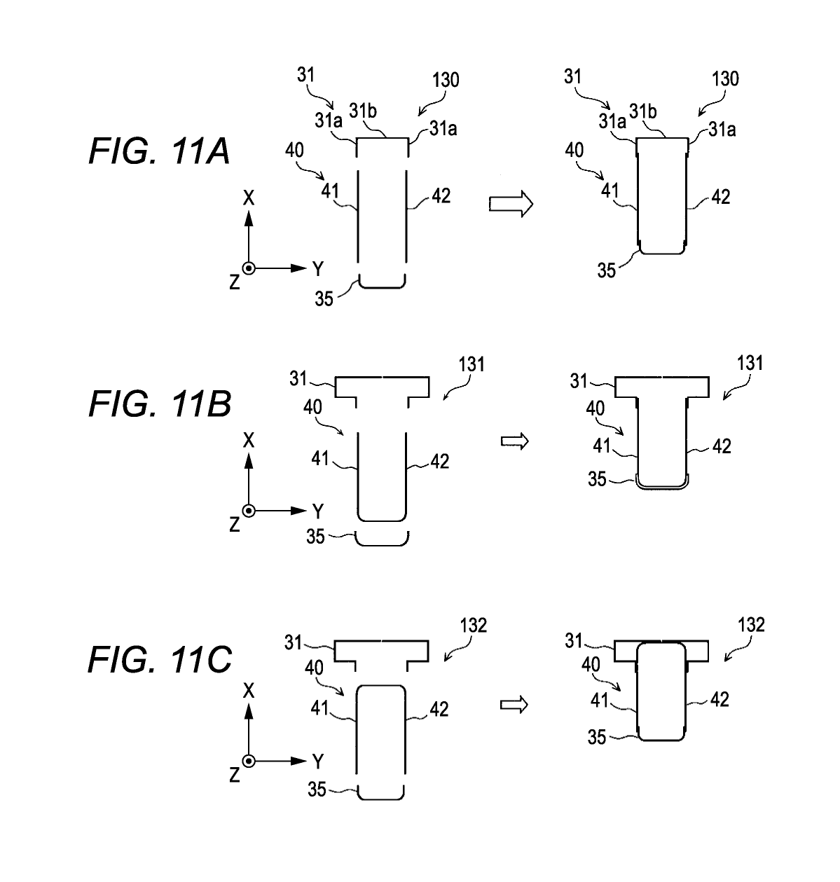

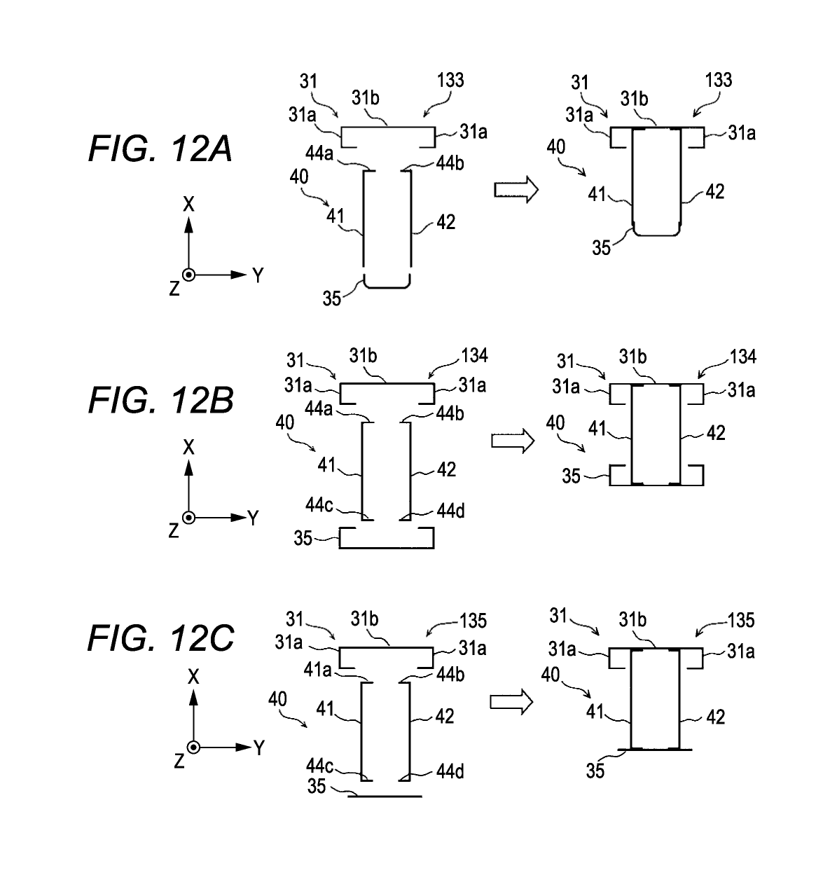

Including this, the mast 30 can adopt various cross-sectional configurations. Accordingly, some modification examples of the cross-sectional configuration of the mast 30 will be described with reference to FIGS. 11A to 12C.

FIGS. 11A, 11B, and 11C are first diagrams illustrating a plurality of modification examples of the cross-sectional configuration of the mast 30, and FIGS. 12A, 12B, and 12C are second diagrams illustrating a plurality of modification examples of the cross-sectional configuration of the mast 30.

For instance, like a mast 130 illustrated in FIG. 11A, the roller abutting member 31 is not required to be projected at both ends in the Y-axis direction. That is, both ends of the first plate material in top view may be folded to form the roller abutting member 31 including the two first abutting surfaces 31a and the one second abutting surface 31b.

In addition, in this preferred embodiment, the first coupling surface 41 and the second coupling surface 42 of the coupling member 40 preferably are separated from each other. However, as illustrated in FIGS. 11B and 11C, the first coupling surface 41 and the second coupling surface 42 may be integrated with each other to form a single monolithic unitary member.

Specifically, the coupling member 40 may integrally include the first coupling surface 41 and the second coupling surface 42 by folding a third plate material.

Like the first plate material, SS400 or SPHC is preferably used as the third plate material, for example.

For instance, as illustrated in FIG. 11B, it is assumed that the coupling member 40 is arranged in a mast 131 so that the coupling portion of the first coupling surface 41 and the second coupling surface 42 is located on the back-side member 35 side. In this case, for instance, the rigidity of the outside (the opposite side of the platform 51) portion of the mast 131 can be further improved.

In addition, for instance, as illustrated in FIG. 11C, it is assumed that the coupling member 40 is arranged in a mast 132 so that the coupling portion of the first coupling surface 41 and the second coupling surface 42 is located on the roller abutting member 31 side. In this case, for instance, the contact area of the roller abutting member 31 and the coupling member 40 is increased. Therefore, the roller abutting member 31 and the coupling member 40 can be joined more strongly.

For instance, each of the first coupling surface 41 and the second coupling surface 42 of the coupling member 40 may include a joining portion joining with the portion of the roller abutting member 31 parallel or substantially parallel to the Y-axis.

Specifically, as illustrated in FIG. 12A, the ends of the first coupling surface 41 and the second coupling surface 42 on the roller abutting member 31 side are folded to define joining portions 44a and 44b. This can manufacture a mast 133 in which each of the first coupling surface 41 and the second coupling surface 42 is joined to the portion of the roller abutting member 31 parallel or substantially parallel to the Y-axis.

In this case, for instance, the first connecting member 34 (see FIGS. 3 and 6A) and the roller abutting member 31 can also be joined by the fastening members 60 which join the joining portions 44a and 44b and the roller abutting member 31.

As illustrated in FIG. 12B, the end of the first coupling surface 41 on the opposite side of the joining portion 44a may be folded to define a joining portion 44c, and the end of the second coupling surface 42 on the opposite side of the joining portion 44b may be folded to define a joining portion 44d.

This can manufacture a mast 134 in which each of the first coupling surface 41 and the second coupling surface 42 is joined to the portion of the back-side member 35 parallel or substantially parallel to the Y-axis.

As illustrated in FIG. 12B, the back-side member 35 may have a cross-sectional shape which is the same as or close to that of the roller abutting member 31.

In this case, for instance, the back-side member 35 may have the same function as the roller abutting member 31, that is, the function of guiding the raising and lowering of the platform 51.

That is, the two masts 134 having the cross-sectional shape illustrated in FIG. 12B can be arranged on the right and left sides of the platform 51 (in the X-axis positive and negative directions; the same shall apply hereinafter).

The two platforms 51 may be arranged about the one mast 134, and the raising and lowering of the platforms 51 may be guided by the mast 134.

When the first coupling surface 41 and the second coupling surface 42 include the joining portions 44c and 44d, for instance, as illustrated in FIG. 12C, a mast 135 in which the coupling member 40 and the plate-shaped back-side member 35 are joined.

The stacker crane of the present invention has been described above based on the preferred embodiments thereof. However, the present invention is not limited to the preferred embodiments. Various modifications contrived by those skilled in the art applied to the preferred embodiments or configurations built by combining the components are included in the scope of the present invention without departing from the purport of the present invention.

For instance, the present invention is not particularly limited to the method of joining the members of the mast 30. As the method of joining the members, in place of or in addition to fastening by the fastening members 60, joining by welding or an adhesive may be adopted.

For instance, an adhesive and rivets as the fastening members 60 may be used together to join the members. That is, the members may be joined by combining joining methods, such as fastening by rivets and adhesion by an adhesive.

For instance, a plurality of coupling members 40 are not required to be arranged continuously in the height direction in the mast 30. For instance, the plurality of coupling members 40 may be aligned in the height direction at predetermined intervals.

The first coupling surface 41 and the second coupling surface 42 which are separated from each other may alternate in the height direction.

That is, a plurality of coupling members 40 are discretely arranged when the rigidity required of the mast 30 can be secured. Therefore, the weight of the mast 30 can be further reduced.

A plurality of through-holes 45 are not required to be formed in the coupling member 40 by removing material and reducing weight. That is, the at least one through-hole 45 is preferably formed in at least one of the first coupling surface 41 and the second coupling surface 42.

The first connecting member 34 and the second connecting member 36 are not essential elements in the mast 30. That is, even when the first connecting member 34 is not present, the adjacent two roller abutting members 31 are connected in the height direction via a plurality of coupling members 40 joined thereto. In addition, likewise, even when the second connecting member 36 is not present, the adjacent two back-side members 35 are connected in the height direction via a plurality of coupling members 40.

The mast 30 may include only one of the first connecting member 34 and the second connecting member 36.

For instance, in order that the right and left configurations of the stacker crane 50 about the platform 51 are the same, only one of the first connecting member 34 and the second connecting member 36 may be arranged in each of a pair of masts 30 (see FIG. 1).

The two connecting members maybe provided. For instance, the two first connecting members 34 may be arranged so as to sandwich the joint between the adjacent two roller abutting members 31.

As a result, the strength of the joint between the roller abutting members 31 can be improved to reduce the deformation amount in the joint. In addition, as compared with a case where only the one first connecting member 34 is arranged at the joint, the force applied to the fastening members 60 which join the roller abutting member 31 and the first connecting member 34 can be distributed. As a result, the load resistance of the mast 30 can be improved.

For instance, in place of or in addition to the change of the thickness of each back-side member 35 according to the height position thereof, the thickness of at least one of each roller abutting member 31 and each coupling member 40 may be changed according to the height position thereof.

For instance, when the thickness of each of a plurality of roller abutting members 31 is changed according to the height position thereof, like the back-side members 35 of this preferred embodiment, each of the roller abutting members 31 is sandwiched between the first coupling surface 41 and the second coupling surface 42 of the coupling member 40. As a result, the second abutting surfaces 31b of the roller abutting members 31 can be flat and have no steps.

Referring to FIGS. 4 and 11A to 12C, the cross-sectional configurations of the mast 30 according to the preferred embodiments and modification examples thereof have been described. However, the features of these cross-sectional configurations may be combined to allow the mast to have a different cross-sectional configuration.

The stacker crane of various preferred embodiments of the present invention includes the mast which can secure a predetermined rigidity and can be reduced in weight. Therefore, it is useful as a stacker crane which conveys loads in a factory and a distribution storage.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stacker crane comprising:
a truck frame;
a platform which is raised and lowered, the platform including first and second rollers that raise and lower, the first and second rollers including rotational axes crossing each other; and
a mast erected on the truck frame and guiding the platform, the mast including a roller abutting member in which a first plate material is folded to define a first abutting surface onto which the first roller abuts and a second abutting surface onto which the second roller abuts, a back-side member made of a second plate material and arranged opposite to the roller abutting member, and a coupling member coupling the roller abutting member and the back-side member, the coupling member including first and second coupling surfaces which are plate-shaped and are opposite to each other; wherein
a thickness of the first and second coupling surfaces is smaller than a thickness of the first plate material.

2. The stacker crane according to claim 1, wherein
the mast includes a plurality of roller abutting members, a plurality of back-side members, and a plurality of coupling members;
the plurality of roller abutting members are aligned in a height direction;
the plurality of back-side members are aligned in the height direction;
the plurality of coupling members are aligned in the height direction;
the mast further includes a connecting member connecting at least adjacent pairs of the roller abutting members.

3. The stacker crane according to claim 2, wherein the plurality of roller abutting members, the plurality of back-side members, and the plurality of coupling members are arranged in the mast such that at least one boundary position between the aligned roller abutting members is not the same in the height direction as at least one of the boundary position between the back-side members and the boundary position between the coupling members.

4. The stacker crane according to claim 2, wherein in at least two of the back-side members, the back-side member arranged in a lower position has a larger thickness than the back-side member arranged in a higher position.

5. The stacker crane according to claim 4, wherein each of the plurality of back-side members is made of a folded second plate material, and is sandwiched between the first and second coupling surfaces of the coupling member.

6. The stacker crane according to claim 5, wherein each of the plurality of back-side members is arranged in a position in which a surface thereof opposite to the roller abutting member defines a flat surface.

7. The stacker crane according to claim 1, wherein the coupling member includes a through-hole in at least one of the first and second coupling surfaces, and a bulging portion bulging outward or inward, the bulging portion increasing a strength of the coupling member.

8. The stacker crane according to claim 1, wherein the coupling member includes the first and second coupling surfaces, which are separated from each other.
